(19) United States
(12) Patent Application Publication
(10) Pub. No.: US 2006/0234873 A1
(43) Pub. Date: Oct. 19, 2006

(54) Thermal stability agent for maintaining viscosity and fluid loss properties in drilling fluids

(75) Inventor: David Ballard, Stonehaven (GB)

Correspondence Address: CARTER J. WHITE LEGAL DEPARTMENT;M-I L.L.C., 5950 NORTH COURSE DRIVE, HOUSTON, TX, 77072, US

(73) Assignee: M-I L.L.C., Houston, TX (US)

(21) Appl. No.: 11/425,696

(22) Filed: Jun. 21, 2006

Related U.S. Application Data
(63) Continuation of application No. 10/957,112, filed on Oct. 1, 2004.
(60) Provisional application No. 60/508,189, filed on Oct. 2, 2003.

(51) Int. Cl. C09K 8/68; C09K 8/60

(52) U.S. Cl. 507/211; 507/267

(57) ABSTRACT

A method of increasing the thermal stability of an aqueous wellbore fluid that includes a viscosifying agent, involves formulating the wellbore fluid so as to include an effective amount of a thermal stability compound selected from the group of gallic acid, gallow tannins, esters of gallic acid, salts of gallic acid and combinations of these compounds. The inclusion of the thermal stability agent surprisingly enhances the ability of the wellbore fluid to maintain viscosity and fluid loss properties upon exposure to high temperatures. Preferably the thermal stability agent is gallic acid or substantially pure 3,4,5-trihydroxybenzoic acid. The concentration of the thermal stability compound is from about 0.1% by weight to about 10% by weight of the wellbore fluid. The wellbore fluid is formulated to include a viscosifying agent such as starch, schleroglucans, guar gums, polyacrylates, xanthan gum, and combinations of these and similar compounds. Optionally, the wellbore fluid is formulated to include a weighting agent such as barite, hematite, iron oxide, calcium carbonate, alkali halides, alkaline earth halides, magnesium carbonate, zinc halides, zinc formats, zinc acetates, cesium halides, cesium formats, cesium acetates, and combinations of these and similar compounds.

This is the non-provisional of U.S. Provisional Application No. 60/508,189, filed Oct. 2, 2004, the contents of which are hereby incorporated by reference.

### BACKGROUND

Water based drilling fluids often contain viscosifying agents such as starches, schleroglucans, polyacrylates, and a wide variety of synthetic and natural polymers to establish and control the theological properties of the drilling fluid. During the course of drilling a subterranean well, water based drilling fluids are exposed to temperatures that can be in excess of 300° F. Exposure to such temperatures can have a detrimental effect on viscosifying agents, resulting in a loss in viscosity of the fluid at high temperatures. A breakdown of the rheology, i.e. loss in viscosity, can result in the drilling fluid being unable to suspend the solids dispersed within it such as the weighting or bridging agent or even the drill cuttings which can lead to severe problems such as settlement, loss in fluid density and possibly a blowout of the well.

One of skill in the art will appreciate that at least a portion of the loss in viscosity is the result of the drilling fluid becoming less viscous as the temperature of the drilling fluid increases. However, this thermally induced loss in viscosity does not fully explain the observed drop in viscosity at higher temperatures (i.e. temperatures over 100 F) over time. It has been reported that one likely cause for the loss in viscosity is the degradation of the polymers, starches, and other compounds used as viscosifying agents in the drilling fluid. A wide variety of compositions have been used to try and delay the degradation of viscosifying agents and to extend the temperature limit at which a particular drilling fluid formulation can be used. Two materials commonly added to help stabilize the high temperature rheology of a drilling fluid are magnesium oxide and monoethanolamine. Both compounds serve as to buffer the pH of the drilling fluid and thus maintain the alkaline conditions under which the process of hydrolysis or degradation of the polymers is retarded. Despite the widespread use of these compounds, there exists an unmet need for environmentally acceptable additive to replace monoethanolamine as its use has been restricted by in many areas due to its harmful nature.

Thus there remains a continuing need for new compounds to improve the thermal stability of viscosified, aqueous wellbore fluids.

### SUMMARY

The claimed subject matter is generally directed to a method of increasing the thermal stability of an aqueous wellbore fluid that includes a viscosifying agent. The method involves formulating the wellbore fluid so as to include an effective amount of a thermal stability compound. In a preferred illustrative embodiment, the thermal stability compound is selected from the group including gallic acid, gallow tannins, esters of gallic acid, salts of gallic acid as well as mixtures and combinations of these and similar compounds. The role of the thermal stability agent is to maintain viscosity and fluid loss properties in the wellbore fluid as it becomes exposed to increased temperatures encountered during drilling and production of oil and gas from subterranean formations.

A preferred and illustrative formulation uses substantially pure 3,4,5-trihydroxybenzoic acid, which is also known as gallic acid. The effective amount of thermal stability agent may range from about 0.1% by weight to about 10% by weight of the wellbore fluid. The illustrative wellbore fluid may be formulated to include a wide variety of additives known to be useful in well bore fluids. For example the well bore fluid may be formulated to include viscosifying agents such as starch, schleroglucans, guar gums, polyacrylates, xanthan gum, or combinations of these and similar compounds. A weighting agent may also be included in the wellbore fluid so as to achieve a desired density for the fluid. Illustrative weighting agents include barite, hematite, iron oxide, calcium carbonate, alkali halides, alkaline earth halides, magnesium carbonate, zinc halides, zinc formates, zinc acetates, cesium halides, cesium formates, cesium acetates, and combinations of these and other compounds that should be well known to one of skill in the art.

The claimed subject matter also encompasses a aqueous based wellbore fluid including a viscosifying agent and a thermal stability agent as is substantially disclosed herein. The wellbore fluid exhibits surprising properties of thermal stability that exceed those exhibited by the prior art. The illustrative aqueous wellbore fluid includes an effective amount of a thermal stability compound which is preferably selected from the group including gallic acid, gallow tannins, esters of gallic acid, salts of gallic acid and combinations of these compounds. The inclusion of these thermal stability agents are believed to significantly and surprisingly contribute to maintaining viscosity and fluid loss properties in the aqueous wellbore fluid. In one preferred and illustrative embodiment substantially pure gallic acid in the form of 3,4,5-trihydroxybenzoic acid is utilized. An effective amount of the thermal stability agents disclosed herein range from about 0.1% by weight to about 10% by weight of the wellbore fluid. The viscosifying agent utilized in formulating the wellbore fluid is preferably selected from the group including starch, schleroglucans, guar gums, polyacrylates, xanthan gum, and combinations of these and similar compounds that should be well known to one of skill in the art. The illustrative wellbore fluid may further include a weighting agent such as one selected from the group of barite, hematite, iron oxide, calcium carbonate, alkali halides, alkaline earth halides, magnesium carbonate, zinc halides, zinc formats, zinc acetates, cesium halides, cesium formats, cesium acetates, and combinations of these and similar compounds that should be well known to one of skill in the art.

Further illustrative embodiments of the claimed subject matter are discussed in greater detail below.

### DESCRIPTION OF ILLUSTRATIVE EMBODIMENTS

Thermally induced oxidation of the viscosifying agents in wellbore fluids and more specifically drilling fluids is thought to be an important reason for the rheology degradation within a drilling fluid at high temperature. Gallic acid, 3,4,5-trihydroxybenzoic acid, is found widely in plants, especially as a component of gallotannins, which in their own right might also have beneficial properties. Gallic acid is known as a reducing agent and an oxygen scavenging agent in aqueous solution. Further ester derivatives of gallic acid are known to serve as antioxidants. For these reasons, these materials have been tested as temperature stability agents in drilling fluids. Surprisingly, the addition of an effective amount of gallic acid, gallow tannins, esters of gallic acid, salts of gallic acid and combinations of these compounds have been found to be highly effective at slowing the breakdown of the viscosifying polymers. Based on the results disclosed herein, an amount from about 0.1% by weight to about 10% by weight of a thermal stability agent has been found to be effective for the drilling fluids disclosed herein. In a preferred illustrative embodiment, substantially pure gallic acid, also known as 3,4,5-trihydroxybenzoic acid has been found to be particularly effective as a thermal stability agent. Support for this ability of gallic acid to stabilize viscosified wellbore fluids can be found in the examples below. Alternatively a mixture of one or more compounds selected from the group gallic acid, gallow tannins, esters of gallic acid, salts of gallic acid and combinations of these compounds may be utilized within the same concentration range of about 0.1% to about 10% by weight of the fluid.

The formulation of a drilling fluid itself should be well known to one of skill in the art. Generally drilling fluids are characterized by the characteristics of the compound or mixture of compounds that make up the continuous phase of the drilling fluids For example an aqueous-based drilling fluid is principally composed of an aqueous solution as the continuous phase. The aqueous based continuous phase may generally be any water based fluid phase that is compatible with the formulation of a drilling fluid and is compatible with the shale hydration inhibition agents disclosed herein. In one preferred embodiment, the aqueous based continuous phase is selected from: fresh water, sea water, brine, mixtures of water and water soluble organic compounds and mixtures thereof. The amount of the aqueous based continuous phase should be sufficient to form a water based drilling fluid. This amount may range from nearly 100% of the drilling fluid to less than 30% of the drilling fluid by volume. Preferably, the aqueous based continuous phase is from about 95 to about 30% by volume water and preferably from about 90 to about 40% by volume of the drilling fluid.

In addition to the aqueous continuous phase, the aqueous based drilling fluid typically includes polymeric viscosifying agent and a fluid loss control agent or simply a fluid loss agent. The drilling fluids of the claimed subject matter include a viscosifying agent in order to alter or maintain the rheological properties of the fluid. The primary purpose for such viscosifying agents is to control the viscosity and potential changes in viscosity of the drilling fluid. Viscosity control is particularly important because often a subterranean formation may have a temperature significantly higher than the surface temperature. Thus a drilling fluid may undergo temperature extremes of nearly freezing temperatures to nearly the boiling temperature of water or higher during the course of its transit from the surface to the drill bit and back. One of skill in the art should know and understand that such changes in temperature can result in significant changes in the theological properties of fluids. Thus in order to control and/or moderate the rheology changes, viscosity agents and rheology control agents may be included in the formulation of the drilling fluid. Viscosifying agents suitable for use in the formulation of the drilling fluids of the claimed subject matter may be generally selected from any type of viscosifying agents suitable for use in aqueous based drilling fluids. Specifically, natural and synthetic polymers that impart the desired theological characteristics to the drilling fluid are useful in the formulation of the wellbore fluids disclosed herein. Such viscosifying agents, for example may include, starch, schleroglucans, guar gums, polyacrylates, xanthan gum, as well as combinations of these compounds

The drilling fluids of the claimed subject matter can include a weight material in order to increase the density of the fluid. The primary purpose for such weighting materials is to increase the density of the drilling fluid so as to prevent kick-backs and blow-outs. One of skill in the art should know and understand that the prevention of kick-backs and blow-outs is important to the safe day to day operations of a drilling rig. Thus the weight material is added to the drilling fluid in a functionally effective amount largely dependent on the nature of the formation being drilled. Weight materials suitable for use in the formulation of the drilling fluids of the claimed subject matter may be generally selected from any type of weighting materials be it in solid, particulate form, suspended in solution, dissolved in the aqueous phase as part of the preparation process or added afterward during drilling. It is preferred that the weight material be selected from the group including barite, hematite, iron oxide, calcium carbonate, alkali halides, alkaline earth halides, magnesium carbonate, zinc halides, zinc formates, zinc acetates, cesium halides, cesium formates, cesium acetates, as well as other well known organic and inorganic salts, and mixtures and combinations of these compounds and similar such weight materials that may be utilized in the formulation of drilling fluids.

In addition to the components noted above, the claimed drilling fluids may also be formulated to include materials generically referred to as gelling materials, thinners, and fluid loss control agents, as well as other compounds and materials which are optionally added to water base drilling fluid formulations. Of these additional materials, each can be added to the formulation in a concentration as theologically and functionally required by drilling conditions. Typical fluid loss control agents and gelling materials used in aqueous based drilling fluids are polyanionic carboxymethylcellulose (PAC or CMC), chemically modified starches, bentonite, sepiolite, clay, attapulgite clay, anionic high-molecular weight polymers and biopolymers.

Thinners such as lignosulfonates are also often added to water-base drilling fluids. Typically lignosulfonates, modified lignosulfonates, polyphosphates and tannins are added. In other embodiments, low molecular weight polyacrylates can also be added as thinners. Thinners are added to a drilling fluid to reduce flow resistance and control gelation tendencies. Other functions performed by thinners include reducing filtration and filter cake thickness, counteracting the effects of salts, minimizing the effects of water on the formations drilled, emulsifying oil in water, and stabilizing mud properties at elevated temperatures.

Other additives that could be present in the drilling fluids of the claimed subject matter include products such as shale inhibition agents, shale encapsulation agents, such as polyamides and glycols, lubricants, penetration rate enhancers, defoamers, corrosion inhibitors and loss circulation products. Such compounds should be known to one of ordinary skill in the art of formulating aqueous based drilling fluids.

The above discussion has discussed the application of the claimed subject matter to a drilling fluids, such as drilling mud, completion fluid, workover fluids and the like. However, one of skill in the art should immediately appreciate that the utilization of the thermal stability agents disclosed herein may extended to other types of viscosified wellbore fluids such as cementing fluids, fracturing fluids, packer fluids, annulus fluids, and the like which are utilized in the drilling and production of oil and gas from subterranean wells. Thus it is contemplated that the application of the thermal stability agents disclosed herein may be more extensive than is disclosed above and the use of the term “wellbore fluid” is intended to encompass that broader class of viscosified fluids.

The following examples are included as demonstrative preferred embodiments. It should be appreciated by those of skill in the art that the techniques disclosed in the examples which follow represent techniques discovered by the inventors to function well in the practice of what is claimed, and thus can be considered to constitute preferred modes of practice. However, those of skill in the art should, in light of the present disclosure, appreciate that many changes can be made in the specific embodiments which are disclosed and still obtain a like or similar result without departing from the scope of what is claimed.

The following example illustrates the fluids of the present disclosure by formulating a fluid illustrative of the prior art and a fluid formulated to include gallic acid at a 3 pounds per barrel (ppb) concentration. Two different base fluid formulations were utilized as shown below:

Fluid Formulation for 1 scale lab barrel (350 ml)

| | | CaCl₂ |
|---|---|---|
| | Na/KCl | based |
| Material (g/350 ml) | based fluid | fluid |
| 1.22 S.G Na/KCl brine | 402.4 | |
| 1.14 S.G CaCl₂ brine | | 374.5 |
| BIOCIDE | 0.2 | |
| DEFOAMER | 0.2 | 0.2 |
| XANTHAN GUM VISCOSIFIER | 1.25 | |
| SCLEROGLUCAN GUM VISCOSIFIER | | 1.5 |
| STARCH BASED FLUID LOSS ADDITIVE | 6 | 6 |
| CALCIUM CARBONATE BRIDGING SOLID | 40 | 40 |
| MAGNESIUM OXIDE | 2 | 2 |

Fluid Density (lb/gal) 10.7 and 10.1

All the tests were carried out using the standard API testing procedure (13 B/l). The rheologies were measured at 120° F. before hot rolling (BHR) and after hot rolling (AHR).

Rheological properties of the Na/KCl base fluid BHR and AHR for 16 hrs @ 250° F., 275° F. and 300° F. without the addition of gallic acid

Sample:

| | BHR | AHR | AHR | AHR |
|---|---|---|---|---|
| aging temp (F.) | | 250 | 275 | 300 |
| 600 rpm | 79 | 43 | 46 | 33 |
| 300 rpm | 59 | 29 | 31 | 21 |
| 6 rpm | 12 | 6 | 6 | 4 |
| 3 rpm | 14 | 5 | 5 | 3 |
| PV | 20 | 14 | 15 | 12 |
| YP | 39 | 15 | 16 | 9 |
| Gels | | | | |
| 10 s | 16 | 6 | 6 | 3 |
| 10 m | — | — | — | — |
| pH | 10.1 | 8.9 | 8.7 | 8.5 |

Rheological properties of the Na/KCl base fluid BHR and AHR for 16 hrs @ 250° F., 275° F. and 300° F. with the addition of gallic acid (3 g)

Sample:

| | BHR | AHR | AHR | AHR |
|---|---|---|---|---|
| aging temp (F.) | | 250 | 275 | 300 |
| 600 rpm | 80 | 65 | 76 | 67 |
| 300 rpm | 60 | 56 | 62 | 56 |
| 6 rpm | 20 | 24 | 28 | 20 |
| 3 rpm | 17 | 21 | 28 | 18 |
| PV | 20 | 9 | 14 | 11 |
| YP | 40 | 47 | 48 | 45 |
| Gels | | | | |
| 10 s | 19 | 21 | 27 | 19 |
| 10 m | — | — | — | — |
| pH | 10.0 | 8.0 | 9.7 | 9.6 |

Upon review of the above results one of skill in the art should appreciate that adding the equivalent of 3 lb/bbl of gallic acid to the Na/KCl base fluid helps to stabilize the rheology after ageing. This is exemplified by the Yield Point (YP) and the 10 second Gel strength results before and after ageing at 300° F. Further it will be noted that the YP and Gel for the fluid without gallic acid drops from 39 to 9 and the 10 second Gel strength drops from 16 to 3. In contrast, the fluid containing gallic acid has a YP of 45 and a 10 second Gel of 19, which is similar to the value before ageing, indicating that degradation of the viscosifying polymers has been minimized.

Rheological properties of the CaCl₂ base fluid BHR and AHR for 16 hrs @ 250° F., 275° F. and 300° F. without the addition of gallic acid

Sample:

| | BHR | AHR | AHR | AHR |
|---|---|---|---|---|
| aging temp (F.) | | 250 | 275 | 300 |
| 600 rpm | 85 | 61 | 48 | 20 |
| 300 rpm | 63 | 45 | 33 | 12 |
| 6 rpm | 20 | 13 | 6 | 2 |
| 3 rpm | 18 | 11 | 5 | 1 |
| PV | 22 | 16 | 15 | 8 |
| YP | 41 | 29 | 18 | 4 |
| Gels | | | | |
| 10 s | 20 | 14 | 7 | 2 |
| 10 m | — | — | — | — |
| pH | 10.1 | 9.0 | 9.1 | 9.0 |

Rheological properties of the CaCl₂ base fluid BHR and AHR for 16 hrs @ 250° F., 275° F. and 300° F. with the addition of gallic acid (3 g)

Sample:

| | BHR | AHR | AHR | AHR |
|---|---|---|---|---|
| aging temp (F.) | | 250 | 275 | 300 |
| 600 rpm | 79 | 75 | 71 | 63 |
| 300 rpm | 58 | 55 | 56 | 52 |
| 6 rpm | 16 | 16 | 23 | 12 |
| 3 rpm | 13 | 14 | 20 | 10 |
| PV | 21 | 20 | 15 | 11 |
| YP | 37 | 35 | 41 | 41 |
| Gels | | | | |
| 10 s | 16 | 17 | 21 | 12 |
| 10 m | — | — | — | — |
| pH | 10.1 | 8.2 | 8.9 | 9.1 |

Upon review of the above data, one of skill in the art should appreciate the results demonstrate an increase in rheological stability from the use of gallic acid. Upon aging one of skill in the art would see that the theological profile of the base fluid is unacceptable. This is shown by the solids settling to the bottom of the hot rolling cell during cooling and thermo cup during the rheology measurement. In contrast, the fluid formulated in accordance with the teachings of the present disclosure, the solids remain fully suspended in the fluid containing gallic acid. Additionally, these above results demonstrate to one of skill in the art that gallic acid is effective in different types of drilling fluid as this fluid contained scleroglucan gum and calcium chloride compared to a fluid that is based upon xanthan gum and sodium and potassium chloride.

In the following examples the effectiveness of additions of gallic acid to reduce the thermal degradation effects observed on theological and filtration control properties and sag characteristics of various aqueous based fluid systems after aging at elevated temperatures. Upon review one of skill in the art will appreciate that gallic acid functions as a highly effective polymer temperature stabilizer in the fluid systems tested.

A variety of water based drilling muds were prepared. The descriptions of the fluid formulations are given below. Each fluid was hot rolled for 16 hours at various temperatures in the 250-320° F. range. Fluid properties were tested using standard API procedures and equipment; the rheology was measured at 120° F. and the API fluid loss (FL) at 100 psi after 30 min.

Evaluation of the Effectiveness of Gallic Acid in a High Temperature Reservoir Drilling Fluid (HT RDF) Formulation

A typical reservoir drilling fluid formulation containing KCl, CaCO₃, XC-polymer, DUALFLO HT was prepared. To buffer the pH various additions of gallic acid and MgO were made before hot rolling.

The test sequence was extended to see if there was any beneficial effect from using the sodium salt of gallic acid, as opposed to magnesium by replacing the MgO buffer in the fluid with NaOH to raise the pH to 10.5 before hot rolling as illustrated in table 4.

TABLE 1
MgO Buffered High Temperature RDF 9.6 ppg or 1.15 SG
Formulation for 1 Lab Barrel (g or ml per 350 ml)

| Additive | Quantity | |
|---|---|---|
| Water | 313 | ml |
| ANTIFOAM A | 0.2 | |
| M-I Cide | 0.2 | |
| KCl | 27 | |
| SAFECARB FINE | 55 | |
| DUOVIS | 1 | |
| DUALFLO HT | 5 | |
| MgO | 0.5 | |

TABLE 2
Fluid Properties Before and After Hot Rolling (BHR, AHR) @ 275° F. for 16 hrs

| | | Mud | | | | | 10 sec. | 30 min. | |
|---|---|---|---|---|---|---|---|---|---|
| Ref. | Sample Variations | pH | PV | YP | 6 rpm | 3 rpm | gel | API | Comments |
| A5 | Base (BHR) | 10.9 | 9 | 19 | 7 | 5 | 6 | — | |
| A5 | Base (AHR) | 9.5 | 5 | 7 | 3 | 2 | 3 | 12.8 | Solids |
| | | | | | | | | | settlement |
| A1 | Base (AHR) + 0.5 g | 8.5 | 8 | 26 | 16 | 14 | 12 | 10.8 | |
| | MgO + 3 g | | | | | | | | |
| | gallic acid | | | | | | | | |
| A2 | Base (AHR) + 1 g | 8.3 | 6 | 29 | 17 | 15 | 11 | 11.5 | |
| | MgO + 5 g gallic | | | | | | | | |
| | acid | | | | | | | | |
| A7 | Base (AHR) + 5 g | 9.7 | 10 | 13 | 3 | 2 | 3 | 25 ml | |
| | MgO + 5 g gallic | | | | | | | (30 sec.) | |
| | acid | | | | | | | | |
| A8 | Base (AHR) + 5 g | 9.9 | 13 | 12 | 3 | 2 | 3 | 25 ml | |
| | MgO + 2.5 g | | | | | | | (30 sec.) | |
| | gallic acid | | | | | | | | |
| A9 | Base (AHR) + 2.5 g | 9.3 | 11 | 14 | 6 | 5 | 6 | 21.5 | |
| | MgO + 5 g | | | | | | | | |
| | gallic acid | | | | | | | | |

TABLE 3
Fluid Properties Before and After Hot Rolling (BHR, AHR) @ 300° F. for 16 hrs

| | | Mud | | | | | 10 sec. | 30 min. | |
|---|---|---|---|---|---|---|---|---|---|
| Ref. | Sample Variations | pH | PV | YP | 6 rpm | 3 rpm | gel | API | Comments |
| A5 | Base (BHR) | 10.9 | 9 | 19 | 7 | 5 | 6 | — | |
| A6 | Base (AHR) | 8.9 | 4 | 2 | 1 | 1 | 2 | 8.1 | Solids |
| | | | | | | | | | settlement |
| A3 | Base (AHR) + 0.5 g | 8.4 | 9 | 10 | 3 | 2 | 3 | 11.7 | |
| | MgO + 3 g | | | | | | | | |
| | gallic acid | | | | | | | | |
| A4 | Base (AHR) + 1 g | 8.2 | 4 | 1 | 1 | 1 | 1 | 6.7 | Solids |
| | MgO + 5 g gallic | | | | | | | | settlement |
| | acid | | | | | | | | |

TABLE 4
Caustic Buffered High Temperature Reservoir Drilling Fluid 9.6 ppg or
1.15 SG Formulation for 1 Lab Barrel (g or ml per 350 ml)

| Additive | Quantity | |
|---|---|---|
| Water | 313 | ml |
| Antifoam A | 0.2 | |
| M-I Cide | 0.2 | |
| KCl | 27 | |
| SAFECARB FINE | 55 | |
| DUOVIS | 1 | |
| DUALFLO HT | 5 | |

| | |
|---|---|
| NaOH (10% w/v) | To pH 10.5 |

TABLE 5
Fluid Properties Before and After Hot Rolling (BHR, AHR) @ 275° F. for 16 hrs

| | | | | | | | 10 sec. | 30 min. | |
|---|---|---|---|---|---|---|---|---|---|
| Ref. | Sample Variations | Mud pH | PV | YP | 6 rpm | 3 rpm | gel | API | Comments |
| A10 | NaOH Base (AHR) | 7.6 | 4 | 2 | 2 | 1 | — | 25 ml | Solids |
| | | | | | | | | (320 sec). | settlement |
| A11 | NaOH Base (AHR) + 1 g | 8.8 | 7 | 18 | 11 | 9 | 10 | 15 | |
| | gallic acid | | | | | | | | |
| A12 | NaOH Base (AHR) + 2 g | 9.6 | 7 | 16 | 9 | 7 | 9 | 18 | |
| | gallic acid | | | | | | | | |

TABLE 6
Fluid Properties Before and After Hot Rolling (BHR, AHR) @ 300° F. for 16 hrs

| | | Mud | | | | | 10 sec. | 30 min. | |
|---|---|---|---|---|---|---|---|---|---|
| Ref. | Sample Variations | pH | PV | YP | 6 rpm | 3 rpm | gel | API | Comments |
| A13 | NaOH Base (AHR) | 6.4 | 2 | 2 | 1 | 1 | 1 | 25 ml | Solids |
| | | | | | | | | (20 sec.) | settlement |
| A14 | NaOH Base (AHR) + 1 g | 8.5 | 7 | 17 | 6 | 4 | 5 | 65 | |
| | gallic acid | | | | | | | | |
| A15 | NaOH Base (AHR) + 2 g | 9.2 | 8 | 17 | 6 | 8 | 6 | 34 | |
| | gallic acid | | | | | | | | |
| A16 | NaOH Base (AHR) + 3 g | 9.4 | 7 | 16 | 7 | 6 | 6 | 21 | |
| | gallic acid | | | | | | | | |
| A17 | NaOH Base (AHR) + 4 g | 9.5 | 7 | 14 | 3 | 2 | 4 | 40.5 | |
| | gallic acid | | | | | | | | |
| A18 | NaOH Base (AHR) + 5 g | 9.6 | 8 | 14 | 5 | 4 | 4 | 36 | |
| | gallic acid | | | | | | | | |

Comparing results at 275° F., A5 (base) and A1 (gallic addition) in table 2, one of skill in the art should appreciate that the gallic acid has stabilized the rheology after hot rolling at 275° F. In fact, it appears as if the gallic acid has boosted the rheology in someway compared to the BHR base values. The fluid loss is also slightly better when compared to the base, although the measurement on the base is unreliable because of the poor suspending characteristics of the fluid. The later results in table 2 suggest that the fluid is sensitive to high levels of MgO and optimum level and ratio of gallic acid and MgO is needed to effectively stabilize the fluid.

The results in table 3 at 300° F. suggest that a fundamental temperature limit has been reached using the starch based fluid loss additive that cannot be stabilized effectively and is probably related to the molecular structure of the starch. Regardless of this, there are some signs that gallic acid is having a positive affect, as shown by fluid A3, which has yield point of 10 compared to the base that only has yield point of 2. The results for fluid A4, again show that the fluid properties are sensitive to the concentration and ratio of gallic acid and MgO as the rheology has collapsed compared to fluid A3. It is worth remembering, at this point, that starch based fluid loss agent can be used in concentrated formate fluids at 300° F., however, the fundamental limit mentioned here is only meant to apply to the non-formate based fluids.

The results in table 5 at 275° F. show that the sodium salt of gallic acid is also an effective temperature stabilizer, compared to the base, the fluid with gallic acid provided much better fluid loss control and rheological properties. It is interesting to note that the boost in rheology from the sodium salt is not as noticeable as from MgO as shown in table 2. Again the results in table 6 at 300° F. show that a fundamental limit has been reached, as the fluid loss for all the samples is quite high. It is also worth noting that the rheological profile of these fluids are better than the corresponding MgO based fluids after aging at 300° F.

Evaluation of the Effectiveness of Gallic Acid in a High Temperature Drilling Fluid Based on Polyanionic Carboxymethylcellulose (PAC) and Starch FLA

A high temperature water based mud formulation containing NaCl, HMP clay, XC-polymer, barite and variable quantities of DUALFLO HT, POLYPAC ELV was prepared. Additions of gallic acid and either MgO or NaOH were made to the base fluids BHR to raise the pH to 10.5.

TABLE 7
MgO Buffered High Temperature 12.3 ppg or 1.48 SG Fluid
Formulation Based on PAC and Starch
for 1 Lab Barrel (g or ml per 350 ml)

| Additive | Quantity | |
|---|---|---|
| Water | 270 | ml |
| NaCl | 52 | |
| POLYPAC ELV | Varied | |
| DUOVIS | 1 | |
| DUALFLO HT | Varied | |
| MgO | Varied | |
| Barite | 170.5 | |
| HMP Clay | 27 | |

TABLE 8
Fluid Properties Before and After Hot Rolling (BHR, AHR) @ 300° F. for 16 hrs

| | | Mud | | | | | 10 sec. | 30 min. | |
|---|---|---|---|---|---|---|---|---|---|
| Ref. | Sample Variations | pH | PV | YP | 6 rpm | 3 rpm | gel | API | Comments |
| C2 | Base AHR Containing | 7.3 | 13 | 3 | 3 | 2 | 4 | 25 ml | Barite |
| | 3 g DUALFLO HT, 2 g | | | | | | | (90 sec.) | settlement |
| | POLYPAC ELV, 3 g MgO | | | | | | | | |
| C1 | Base (AHR) + 3 g | 7.9 | 20 | 17 | 5 | 3 | 7 | 32.0 | |
| | gallic acid + 6 g MgO | | | | | | | | |
| C4 | Base AHR Containing | 7.3 | ˜20 | ˜30 | — | — | — | 44.0 | Barite |
| | 1 g DUALFLO HT, 4 g | | | | | | | | settlement |
| | POLYPAC ELV, 3 g MgO | | | | | | | | |
| C3 | Base (AHR) + 3 g | 7.9 | 31 | 43 | 23 | 19 | 18 | 13.1 | |
| | gallic acid + 6 g MgO | | | | | | | | |

TABLE 9
Caustic Buffered High Temperature 12.4 ppg or 1.5 SG Fluid Formulation
Based on PAC and Starch for 1 Lab Barrel (g or ml per 350 ml)

| Additive | Quantity | |
|---|---|---|
| Water | 270 | ml |
| NaCl | 52 | |
| POLYPAC ELV | Varied | |
| DUOVIS | 1 | |
| DUALFLO HT | Varied | |
| NaOH (10% w/v) | To pH 10.5 | |
| Barite | 170.5 | |
| HMP Clay | 27 | |

TABLE 10
Fluid Properties Before and After Hot Rolling (BHR, AHR) @ 300° F. for 16 hrs

| | | Mud | | | | | 10 sec. | 30 min. | |
|---|---|---|---|---|---|---|---|---|---|
| Ref. | Sample Variations | pH | PV | YP | 6 rpm | 3 rpm | gel | API | Comments |
| C12 | Base AHR Containing | 6.3 | 14 | 11 | 3 | 2 | 3 | 5.5 | Barite |
| | 3 g DUALFLO HT, 2 g | | | | | | | | settlement |
| | POLYPAC ELV | | | | | | | | |
| C10 | Base (AHR) + 2 g | 7.6 | 30 | 38 | 15 | 13 | 15 | 9.0 | |
| | gallic acid | | | | | | | | |
| — | Base AHR Containing | — | — | — | — | — | — | — | |
| | 1 g DUALFLO HT, 4 g | | | | | | | | |
| | POLYPAC ELV | | | | | | | | |
| C11 | Base (AHR) + 2 g | 7.9 | 30 | 30 | 12 | 10 | 12 | 6.5 | |
| | gallic acid | | | | | | | | |

Upon reviewing the above results at 300° F. in table 8 for fluids buffered with MgO one of skill in the art will note that gallic acid again helps to stabilize the rheology AHR compared to the base. This can be seen from the results C2 (base) and C1 (gallic acid addition) where the yield point is 3 and 17 respectively and the fluid loss control is also improved. This trend is also mirrored in the results for the base containing a higher level of PAC (C4) and the equivalent fluid with gallic acid (C3), where the barite in base fluid was settling so quickly that it is hard to make a measurement, regardless, it is still apparent that the yield point of fluid C3 has been retained and the fluid loss is lower, demonstrating improved temperature tolerance imparted to the fluid from the addition of gallic acid. The results once more illustrate the effect that the starch is “burning out” at 300° F. by comparing results C1 for the fluid containing the higher level of starch and C3 for the fluid containing the higher level of PAC, which shows that the PAC based fluid provides improved suspension and fluid loss characteristics compared to the predominantly starch based fluid.

The results in table 10 present the results for fluids buffered with caustic. By comparing fluid C12, which contains mainly starch fluid loss agent, against a corresponding fluid with gallic acid, C10, it can be seen that the fluid containing gallic acid provides a much better theological profile after aging. The fluid loss is slightly higher but this could be due to the fact that the sample was not showing signs of solids settlement like the base. Comparison of results for C12 and C11 confirm the trend witnessed in the previous test results where it was observed that PAC was more temperature stable than the starch based fluid loss agent. By reviewing the results in both tables 8 for the MgO buffered fluids and 10 for the caustic buffered, it can be seen that the sodium salt of gallic acid gives better fluid properties than the Mg salt.

Evaluation of the Effectiveness of Gallic Acid in a High Temperature Fluid Based on a Synthetic Polymer (Driscal D)

A high temperature water based mud containing NaCl, HMP clay, Driscal D and barite was prepared. Additions of gallic acid and MgO or CaO or NaOH were made to raise the pH to 10.5 BHR.

TABLE 11
MgO or NaOH or Lime Buffered High Temperature
12 ppg or 1.4 SG Fluid Formulation Based on Driscal D
for 1 Lab Barrel (g or ml per 350 ml)

| Additive | Quantity | |
|---|---|---|
| Water | 280 | ml |
| NaCl | 26 | |
| DRISCAL D | 3 | |
| Barite | 170.5 | |
| MgO | 3 | |
| Or NaOH (10% w/v) | To pH 10.5 | |
| Or Lime | 1.5 | |
| HMP Clay | 27 | |

TABLE 12
Fluid Properties Before and After Hot Rolling (BHR, AHR) @ 300° F. for 16 hrs

| | | Mud | | | | | 10 sec. | 30 min. | |
|---|---|---|---|---|---|---|---|---|---|
| Ref. | Sample Variations | pH | PV | YP | 6 rpm | 3 rpm | gel | API | Comments |
| E5 | MgO Buffered Base | 8.2 | 40 | 22 | 5 | 3 | 5 | 31.2 | |
| | (AHR) | | | | | | | | |
| E6 | MgO Buffered Base | 7.8 | 50 | 52 | 9 | 6 | 7 | 20.8 | |
| | (AHR) + 2 g | | | | | | | | |
| | gallic acid + 2 g MgO | | | | | | | | |
| E15 | Lime Buffered Base | 8.6 | 24 | 14 | 5 | 4 | 4 | 29.0 | |
| | (AHR) + 2 g | | | | | | | | |
| | gallic acid | | | | | | | | |
| E7 | NaOH Buffered Base | 10.5 | 26 | 30 | 10 | 8 | 11 | — | |
| | (BHR) | | | | | | | | |
| E7 | NaOH Buffered Base | 8.6 | 26 | 10 | 3 | 2 | 3 | 39.7 | |
| | (AHR) | | | | | | | | |
| E8 | NaOH Buffered Base | 8.9 | 22 | 54 | 9 | 7 | 8 | 3.9 | |
| | (AHR) + 2 g | | | | | | | | |
| | gallic acid | | | | | | | | |

TABLE 13
NaOH Buffered High Temperature 12 ppg or 1.4 SG
Fluid Formulation Based on Driscal D for 1
Lab Barrel (g or ml per 350 ml)

| Additive | Quantity |
|---|---|
| Water | 280 ml |
| NaCl | 26 |
| DRISCAL D | 3 |
| Barite | 170.5 |
| NaOH (10% w/v) | To pH 10.5 |
| HMP Clay | 27 |

TABLE 14
Fluid Properties Before and After Hot Rolling (BHR, AHR) @ 300° F. for 16 hrs

| | | Mud | | | | | 10 sec. | 30 min. | |
|---|---|---|---|---|---|---|---|---|---|
| Ref. | Sample Variations | pH | PV | YP | 6 rpm | 3 rpm | gel | API | Comments |
| E7 | NaOH Buffered Base | 10.5 | 26 | 30 | 10 | 8 | 11 | — | |
| | (BHR) | | | | | | | | |
| E7 | NaOH Buffered Base | 8.6 | 26 | 10 | 3 | 2 | 3 | 39.7 | |
| | (AHR) | | | | | | | | |
| E13 | NaOH Buffered Base | 8.9 | 24 | 18 | 5 | 4 | 4 | 9.1 | |
| | (AHR) + 1 g | | | | | | | | |
| | gallic acid | | | | | | | | |
| E14 | NaOH Buffered Base | 9.1 | 20 | 16 | 5 | 3 | 5 | 9.6 | |
| | (AHR) + 2 g | | | | | | | | |
| | gallic acid | | | | | | | | |

TABLE 15
Fluid Properties Before and After Hot Rolling (BHR, AHR) @ 300 and 320° F. for 16 hrs

| Ref. | Sample Variations | Mud pH | PV | YP | 6 rpm | 3 rpm | 10 sec. gel | 30 min. API |
|---|---|---|---|---|---|---|---|---|
| E7 | NaOH Buffered Base | 10.5 | 26 | 30 | 10 | 8 | 11 | — |
| | (BHR) | | | | | | | |
| E7 | NaOH Buffered Base (AHR | 8.6 | 26 | 10 | 3 | 2 | 3 | 39.7 |
| | @ 300° F.) | | | | | | | |
| E16 | NaOH Buffered Base (AHR | 8.7 | 23 | 16 | 5 | 3 | 4 | 11.0 |
| | @ 320° F.) + 2 g gallic acid | | | | | | | |

Upon review of the results E5, E6 and E15 in table 12, one of skill in the art should appreciated that the Ca and Mg salts of gallic acid have minimal effect at stabilizing Driscal D at 300° F. However, results E7 and E8 show the sodium salt is effective; the fluid loss is very low compared to the base, although the viscosity is unexpectedly high. The results E13 and E14 in table 14 show much better Theological and fluid loss control properties compared to the base, E7. The result in table 15 shows that the gallic acid stabilized fluid, E16, has even better properties after aging at 320° F. than the base aged at 300° F. This data suggests that the temperature limit of the Driscal D based fluid with gallic acid has not been reached yet.

Evaluation of the Effectiveness of Gallic Acid in High Temperature GLYDRIL Based Fluid

A high temperature glycol based fluid containing KCl, HMP clay, XC-polymer, POLYPAC ELV, GLYDRIL MC, IDCAP D, barite was prepared. Gallic acid was added to samples of the base BHR and the pH adjusted with NaOH to 10.5. Additional tests were carried out to determine the performance of another polymer temperature stabilizer, PTS-200 (mono-ethanolamine), in comparison with Gallic Acid.

TABLE 16
NaOH or PTS200 Buffered High Temperature 12 ppg or
1.44 SG Glycol Based Fluid Formulation
for 1 Lab Barrel (g or ml per 350 ml)

| Additive | Quantity |
|---|---|
| Water | 266 ml |
| GLYDRIL MC | 14 ml |
| | (5% of liquid phase) |
| KCl | 27 |
| XC | 0.8 |
| POLYPAC ELV | 4 |
| IDCAP D | 2 |
| Barite | 170.5 |
| NaOH (10% w/v) | To pH 10.5 |
| Or PTS200 | 2 |
| HMP Clay | 27 |

TABLE 17
Fluid Properties Before and After Hot Rolling (BHR, AHR) @ 275° F. for 16 hrs

| | Fluid Properties/Sample | Mud | | | | | 10 sec. | 30 min. | |
|---|---|---|---|---|---|---|---|---|---|
| Ref. | Variations | pH | PV | YP | 6 rpm | 3 rpm | gel | API | Comments |
| F1 | NaOH Buffered Base | 10.5 | 27 | 23 | 6 | 5 | 6 | — | — |
| | (BHR) | | | | | | | | |
| F1 | NaOH Buffered Base | 6.0 | 10 | 4 | 2 | 1 | 1 | 6.0 | Barite |
| | (AHR) | | | | | | | | settlement |
| F2 | NaOH Buffered Base | 7.6 | 22 | 21 | 7 | 6 | 7 | 4.0 | OK |
| | (AHR) + 2 g | | | | | | | | |
| | gallic acid | | | | | | | | |

TABLE 18
Fluid Properties Before and After Hot Rolling (BHR, AHR) @ 300° F. for 16 hrs

| | Fluid Properties/Sample | Mud | | | | | 10 sec. | 30 min. | |
|---|---|---|---|---|---|---|---|---|---|
| Ref. | Variations | pH | PV | YP | 6 rpm | 3 rpm | gel | API | Comments |
| F1 | NaOH Buffered Base | 10.5 | 27 | 23 | 6 | 5 | 6 | — | — |
| | (BHR) | | | | | | | | |
| F3 | NaOH Buffered Base | 5.8 | 10 | 0 | 1 | 1 | 1 | — | No API as |
| | (AHR) | | | | | | | | too thin = |
| | | | | | | | | | barite |
| | | | | | | | | | settlement |
| F4 | NaOH Buffered Base | 7.7 | 20 | 21 | 6 | 5 | 6 | 4.3 | OK |
| | (AHR) + 2 g | | | | | | | | |
| | gallic acid | | | | | | | | |
| F5 | PTS 200 Buffered Base | 9.0 | 14 | 17 | 4 | 3 | 4 | 6.8 | Slight barite |
| | (AHR) | | | | | | | | settlement |

TABLE 19
Fluid Properties Before and After Hot Rolling (BHR, AHR) @ 320° F. for 16 hrs

| | Fluid Properties Sample | Mud | | | | | 10 sec. | 30 min. | |
|---|---|---|---|---|---|---|---|---|---|
| Ref. | Variations | pH | PV | YP | 6 rpm | 3 rpm | gel | API | Comments |
| F1 | NaOH Buffered Base | 10.5 | 27 | 23 | 6 | 5 | 6 | — | — |
| | (BHR) | | | | | | | | |
| F6 | NaOH Buffered Base | 5.4 | 8 | 0 | 1 | 1 | 1 | — | No API as |
| | (AHR) | | | | | | | | too thin = |
| | | | | | | | | | barite |
| | | | | | | | | | settlement |
| F7 | NaOH Buffered Base | 7.5 | 13 | 10 | 2 | 1 | 1 | 3.5 | Barite |
| | (AHR) + 2 g | | | | | | | | settlement |
| | gallic acid | | | | | | | | |
| F8 | PTS 200 Buffered Base | 9.3 | 13 | 4 | 1 | 1 | 1 | 6.5 | Barite |
| | (AHR) | | | | | | | | settlement |

Upon review by one of skill in the art, the results in table 17 for fluids aged at 275° F. reflect the trend seen in all the earlier tests showing that the sodium salt of gallic acid improves the suspension and FL characteristics of the GLYDRIL based fluid. The data in table 18 for fluids aged at 300° F. reinforces the earlier findings of the beneficial temperature stabilizing affect of gallic acid. What is significant are the results for F4 and F5 that show that the sodium salt of gallic acid provides improved temperature stabilization compared to another polymer temperature stabilizer (mono-ethanolamine) at an equivalent concentration. The results presented in table 19 for fluids aged at 320° F. show that the temperature limit of the system is being reached, again gallic acid is showing signs of being more effective than mono-ethanolamine as the yield point of gallic acid fluid, F7, is 10 after aging compared to a yield point of 4 for the fluid F8 containing mono-ethanolamine.

While the apparatus, compositions and methods disclosed above have been described in terms of preferred or illustrative embodiments, it will be apparent to those of skill in the art that variations may be applied to the process described herein without departing from the concept and scope of the claimed subject matter. All such similar substitutes and modifications apparent to those skilled in the art are deemed to be within the scope and concept of the subject matter as it is set out in the following claims.

What is claimed is:

1. A method of increasing the thermal stability of an aqueous wellbore fluid, wherein the aqueous wellbore fluid includes a viscosifying agent, the method comprising formulating the wellbore fluid so as to include an effective amount of 3,4,5-trihydroxybenzoic acid thereby maintaining viscosity and fluid loss properties in the wellbore fluid.

2. The method of claim 1, wherein the amount of 3,4,5-trihydroxybenzoic acid is from about 0.1% by weight to 10% by weight of the wellbore fluid.

3. The method of claim 1, wherein the wellbore fluid is formulated to include a viscosifying agent selected from the group consisting of starch, schleroglucans, guar gums, polyacrylates, xanthan gum, and combinations of these compounds.

4. The method of claim 1, wherein the wellbore fluid is formulated to include a weighting agent selected from the group barite, hematite, iron oxide, calcium carbonate, alkali halides, alkaline earth halides, magnesium carbonate, zinc halides, zinc formates, zinc acetates, cesium halides, cesium formates, cesium acetates, and combinations thereof

5. A method of increasing the thermal stability of a wellbore fluid, wherein the aqueous wellbore fluid includes a viscosifying agent, the method comprising formulating the wellbore fluid so as to include an effective amount of a thermal stability compound, wherein the thermal stability compound is selected from the group consisting of gallic acid, gallow tannins, esters of gallic acid, salts of gallic acid and combinations of these compounds, thereby maintaining viscosity and fluid loss properties in the wellbore fluid.

6. The method of claim 5, wherein the amount of thermal stability compound is from about 0.1% by weight to 10% by weight of the wellbore fluid.

7. The method of claim 5, wherein the wellbore fluid is formulated to include a viscosifying agent selected from the group consisting of starch, schleroglucans, guar gums, polyacrylates, xanthan gum, and combinations of these compounds.

8. The method of claim 5, wherein the wellbore fluid is formulated to include a weighting agent selected from the group barite, hematite, iron oxide, calcium carbonate, alkali halides, alkaline earth halides, magnesium carbonate, zinc halides, zinc formates, zinc acetates, cesium halides, cesium formates, cesium acetates, and combinations thereof

9. An aqueous based wellbore fluid, wherein the well bore fluid includes a viscofiying agent, the improvement comprising an effective amount of a thermal stability compound, wherein the thermal stability compound is selected from the group consisting of gallic acid, gallow tannins, esters of gallic acid, salts of gallic acid and combinations of these compounds, thereby maintaining viscosity and fluid loss properties in the wellbore fluid.

10. The wellbore fluid of claim 9, wherein the amount of thermal stability compound is from about 0.1% by weight to 10% by weight of the wellbore fluid.

11. The wellbore fluid of claim 9, wherein the wellbore fluid is formulated to include a viscosifying agent selected from the group consisting of starch, schleroglucans, guar gums, polyacrylates, xanthan gum, and combinations of these compounds.

12. The wellbore fluid of claim 9, wherein the wellbore fluid is formulated to include a weighting agent selected from the group barite, hematite, iron oxide, calcium carbonate, alkali halides, alkaline earth halides, magnesium carbonate, zinc halides, zinc formats, zinc acetates, cesium halides, cesium formats, cesium acetates, and combinations thereof

13. An aqueous based wellbore fluid, wherein the well bore fluid includes a viscofiying agent, the improvement comprising an effective amount of 3,4,5-trihydroxybenzoic acid thereby maintaining viscosity and fluid loss properties in the wellbore fluid.

14. The wellbore fluid of claim 13, wherein the amount of 3,4,5-trihydroxybenzoic acid is from about 0.1% by weight to 10% by weight of the wellbore fluid.

15. The wellbore fluid of claim 13, wherein the wellbore fluid is formulated to include a viscosifying agent selected from the group consisting of starch, schleroglucans, guar gums, polyacrylates, xanthan gum, and combinations of these compounds.

16. The wellbore fluid of claim 13, wherein the wellbore fluid is formulated to include a weighting agent selected from the group barite, hematite, iron oxide, calcium carbonate, alkali halides, alkaline earth halides, magnesium carbonate, zinc halides, zinc formates, zinc acetates, cesium halides, cesium formates, cesium acetates, and combinations thereof
